(19) United States
(12) Patent Application Publication
(10) Pub. No.: US 2026/0274208 A1
(43) Pub. Date: Sep. 17, 2026

(54) WINDSHIELD DEBRIS WIPER

(71) Applicant: International Truck Intellectual Property Company, LLC, Lisle, IL (US)

(72) Inventor: Mark S. Ehlers, Fort Wayne, IN (US)

(73) Assignee: International Truck Intellectual Property Company, LLC, Lisle, IL (US)

(21) Appl. No.: 19/081,043

(22) Filed: Mar. 17, 2025

(51) Int. Cl. B60S 1/34; B60S 1/08; B60S 1/38

(52) U.S. Cl. CPC B60S 1/3418; B60S 1/08; B60S 2001/3834

(57) ABSTRACT

A debris removal system for a window of a vehicle comprises a wiper assembly and a rotatable brushing assembly. The wiper assembly includes a wiper arm that traverses a wiping path along the window and a wiper blade operably coupled with the wiper arm. The rotatable brushing assembly includes an elongated brush having a longitudinal axis and a motor operably coupled with a portion of the elongated brush. The motor rotates the elongated brush about the longitudinal axis. At least a portion of the elongated brush traverses the wiping path along the window.

### FIELD OF THE DISCLOSURE

This disclosure relates generally to debris removal systems, and, more particularly, to debris removal systems for a windshield of a vehicle.

### BACKGROUND

Commercial and/or heavy-duty vehicles such as, for example, trucks, school buses, or other motorized vehicles are oftentimes exposed to environments that encounter or generate dirt and/or other debris. Oftentimes, the debris may adhere to the windshield of the vehicle and may be difficult to remove using conventional wiper blades and windshield washer solvents. Cleaning windshields on commercial vehicles may be more cumbersome and can present safety issues as compared with passenger vehicles due to the height and overall size of the vehicle. Generally speaking, operators may use stepladders and/or similar platforms, in addition to scrubbing devices attached to poles, to reach desired locations on the windshield. Such approaches require an operator to park the vehicle in a safe location (i.e., away from roadways) and exit the vehicle before performing the cleaning process. This process may therefore be time consuming and require additional equipment, therefore reducing overall efficiency and vehicle uptime.

Additionally, some modern vehicles are equipped with advanced driving assistance systems such as, for example, collision avoidance technology, adaptive cruise control technology, and the like. These systems may rely on imaging systems such as cameras disposed behind or otherwise near the vehicle's windshield and may have reduced effectiveness in situations where the windshield is covered with debris. Further, it may be desirable to limit the use of windshield cleaning solutions containing strong chemicals due to environmental concerns.

Accordingly, there is a need for improved devices having improved functionalities.

### SUMMARY

In accordance with a first aspect, a debris removal system for a window of a vehicle comprises a wiper assembly and a rotatable brushing assembly. The wiper assembly includes a wiper arm that traverses a wiping path along the window and a wiper blade operably coupled with the wiper arm. The rotatable brushing assembly includes an elongated brush having a longitudinal axis and a motor operably coupled with a portion of the elongated brush. The motor rotates the elongated brush about the longitudinal axis. At least a portion of the elongated brush traverses the wiping path along the window.

In some examples, at least a portion of the rotatable brushing assembly is operably coupled with the wiper assembly. Further, in some approaches, the elongated brush is operably coupled with the wiper arm.

In some forms, the debris removal system may further include a controller operably coupled with the wiper assembly and the rotatable brushing assembly to control operation thereof. The controller may move the wiper arm to a stationary position to accommodate travel of the elongated brush along the wiping path. Further, in some examples, the controller may pause the elongated brush at a desired location along the wiping path.

In these and other approaches, the controller may cause the elongated brush to traverse the wiping path at a variable speed. In some forms, the elongated brush may traverse the wiping path in a first direction at a first speed and traverse the wiping path in a second direction at a second speed. In some forms, the controller may cause the elongated brush to selectively rotate in a first direction and a second direction.

In some arrangements, the rotatable brushing assembly is mounted at or near an upper portion of the window of the vehicle. Further, in some examples, the wiping path may include a wiper assembly path and a rotatable brushing assembly path. The wiper assembly path may include a first arcuate pattern, and the rotatable brushing assembly path may include a second arcuate pattern. The wiper assembly may traverse the wiper assembly path, and the rotatable brushing assembly may traverse the rotatable brushing assembly path.

In accordance with a second aspect, an approach for removing debris from a vehicle is provided that includes providing a wiper assembly, a rotatable brushing assembly, and a controller communicatively coupled with the wiper assembly and the rotatable brushing assembly to control operation thereof. The wiper assembly includes a wiper arm adapted to traverse a wiping path along a window of the vehicle and a wiper blade operably coupled with the wiper arm. The rotatable brushing assembly includes an elongated brush having a longitudinal axis and a motor operably coupled with a portion of the elongated brush. The motor is adapted to rotate the elongated brush about the longitudinal axis. The controller is adapted to cause at least a portion of the elongated brush to traverse the wiping path along the window.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate examples of concepts that include the claimed invention, and explain various principles and advantages of those examples.

FIG. 1 is a perspective view of an example vehicle having an example debris removal system in which the systems, methods, and/or techniques of the present disclosure may be implemented.

FIG. 2 is an interior perspective view of the example vehicle of FIG. 1 having the example debris removal system in accordance with various examples.

FIG. 3 is an interior perspective view of the example vehicle of FIGS. 1 and 2 in which the example debris removal system is in an operational mode in accordance with various examples.

FIG. 4 is a perspective view of a first example elongated brush for use with the example debris removal system of FIGS. 1-3 in accordance with various examples.

FIG. 5 is a top view of a second example elongated brush for use with the example debris removal system of FIGS. 1-3 in accordance with various examples.

FIG. 6 is a top view of a third example elongated brush for use with the example debris removal system of FIGS. 1-3 in accordance with various examples.

FIG. 7 is a perspective view of an example vehicle having an alternative example debris removal system in accordance with various examples.

FIG. 8 is an interior perspective view of the example vehicle of FIG. 7 having the alternative example debris removal system in accordance with various examples.

FIG. 9 is a block diagram of an example vehicle having an example debris removal system in accordance with various examples.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples. Also, common but well-understood elements that are useful or necessary in a commercially feasible examples are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

The apparatus and method components have been represented where appropriate by conventional symbols in the drawings, showing only those specific details that are pertinent to understanding examples of the present disclosure so as not to obscure the disclosure with details that will be readily apparent to those of ordinary skill in the art having the benefit of the description herein.

Although the figures show parts with clean lines and boundaries, some or all of these lines and/or boundaries may be idealized. In reality, the boundaries and/or lines may be unobservable, blended, and/or irregular. Use of terms such as up, down, top, bottom, side, end, front, back, etc. herein are used with reference to a currently considered or illustrated orientation. If they are considered with respect to another orientation, it should be understood that such terms must be correspondingly modified.

### DETAILED DESCRIPTION

Disclosed examples of the disclosure provide a number of advantages over existing techniques for removing debris from a windshield of a vehicle. Generally speaking, a motorized, rotatable wiper is provided that assists with dislodging bugs and other debris from the windshield so that the conventional windshield wiper and washer system may clear it from the windshield. Notably, such a system may operate safely while the vehicle is still in motion.

Turning to the Figures, a vehicle 10 is provided that includes a window 12 having a lower portion 12a and an upper portion 12b. In the illustrated examples, the vehicle 10 is in the form of a commercial truck, but it is to be appreciated that the vehicle 10 may take any number of forms. Further, the window 12 depicted in the Figures in the form of a windshield. It is to be appreciated that in some examples, the window 12 may be in the form of a rearward-facing window or any other window disposed on the vehicle 10. As also illustrated in the Figures, debris 14 may be disposed on the window 12.

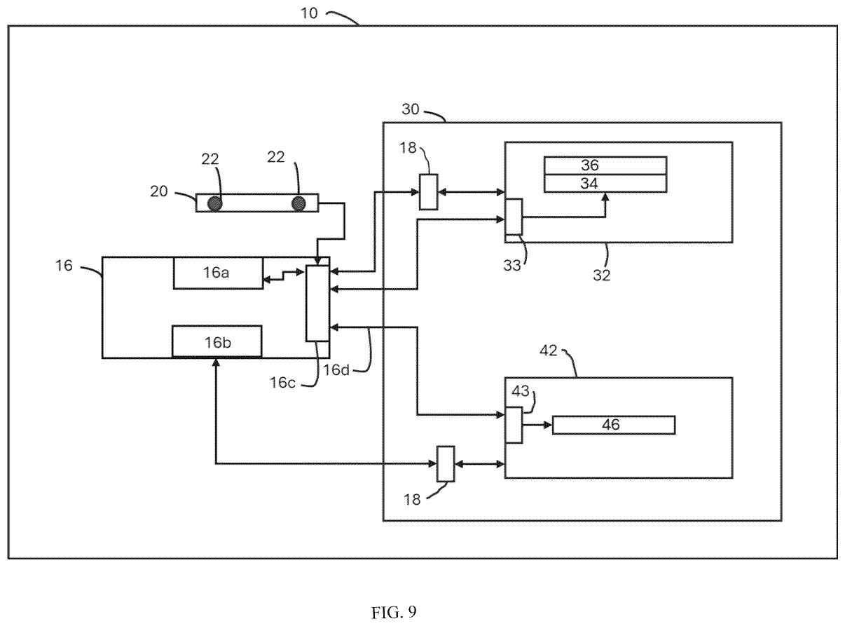

The vehicle 10 may also include a controller 16 and a debris removal system 30 communicatively coupled therewith. In some examples, the controller 16 may be in the form of a control module such as, for example, a Body Control Module (BCM). With particular reference to FIG. 9, the controller 16 may be communicatively coupled with the debris removal system 30 via any type of wired and/or wireless communications protocol adapted to transmit and/or receive electronic signals.

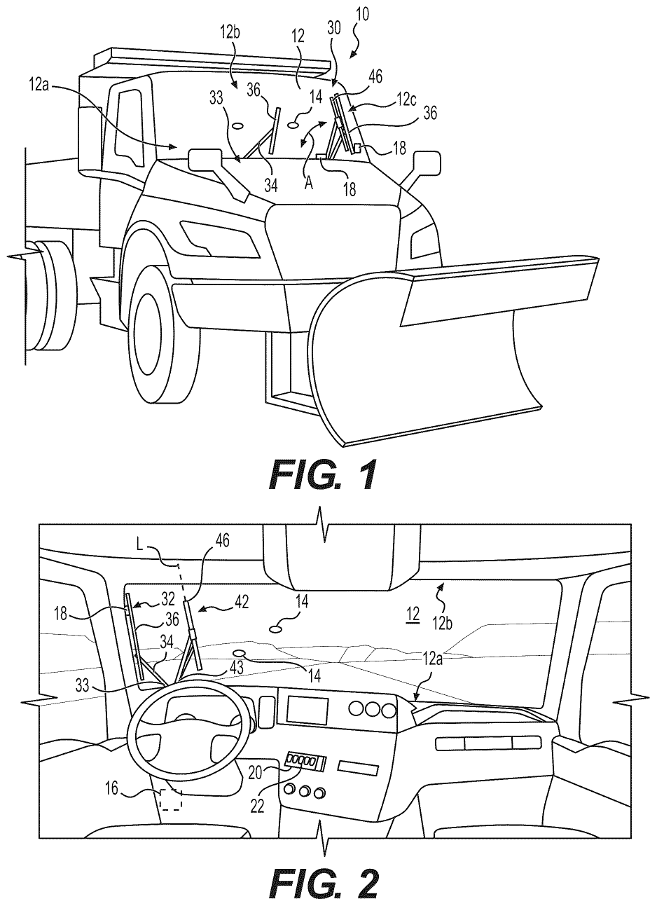

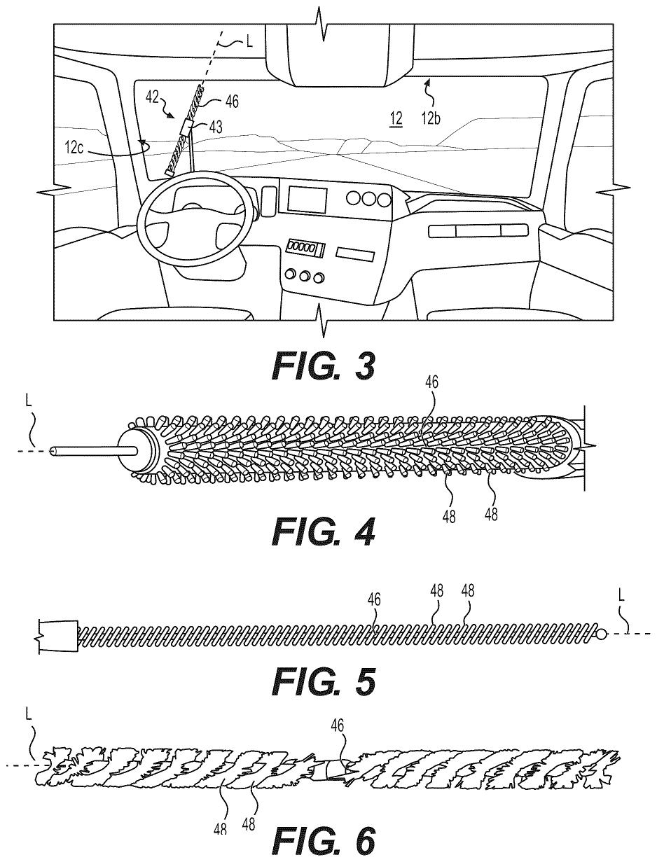

The debris removal system 30 is provided to remove the debris 14 from the window 12 of the vehicle 10. In some examples, the debris removal system 30 includes a wiper assembly 32 having a motor 33, a wiper arm 34 operably coupled with the motor 33, and a wiper blade 36 operably coupled with the wiper arm 34, and further includes a rotatable brushing assembly 42 having a motor 43 and an elongated brush 46 extending along a longitudinal axis L. The motor 33 causes the wiper arm 34, and thus the wiper blade 36, to traverse a wiping path (generally denoted as “A” in FIGS. 1 & 2). In these examples, the wiping path A is a generally arcuate pattern, but other examples are possible. It is to be appreciated that the motors 33, 43 may be electrically powered and/or pneumatically powered.

In the illustrated examples, the motor 33 causes the wiper arm 34 to rotate upwardly from the lower portion 12a of the window 12, but other orientations are possible. The wiper blade 36 may be in the form of any suitable blade that contacts the window 12 while traversing the wiper path A to expel debris 14 therefrom. The wiper blade 36 may be constructed from any number of suitable materials such as, for example, rubber, silicone, or other elastomeric materials. It is to be appreciated that the wiper assembly 32 may include any number of wiper arms and wiper blades as desired to clean the desired surface area of the window 12.

As previously noted, the rotatable brushing assembly 42 includes a motor 43 and an elongated brush 46 that extends along a longitudinal axis L. The elongated brush 46 is operably coupled with the motor 43, which causes the elongated brush 46 to rotate and/or spin about the longitudinal axis L. Further, the motor 43 causes the elongated brush 46 to traverse the wiping path A, therefore causing the elongated brush 46 to move in a sweeping motion along the window 12 while also rotating thereagainst. In some arrangements, the motor 43 may be disposed at or near the lower portion 12a of the window 12 and may be positioned adjacent to or near the motor 33 of the wiper assembly 32. In other implementations, the motor 43 may be integrally formed with the motor 33, meaning a single motor housing (not illustrated) may accommodate both the wiper arm 34 and the elongated brush 46. In some forms, such a motor housing may accommodate distinct motors to operate the wiper arm 34 and the elongated brush 46, but in some forms, a single motor may be provided that can separately actuate the wiper arm 34 and the elongated brush 46. Other arrangements are possible.

The motor 43 may take any number of suitable forms. For example, the motor 43 may be a single speed, multi-speed, or variable speed motor capable of generating a driving torque. In some approaches, the motor may be a brushed or brushless motor operating at 12v or higher voltages.

The elongated brush 46 is driven by the motor 43. The elongated brush 46 includes a number of bristle members 48 projecting radially from the longitudinal axis L. The bristle members 48 may be constructed from any number of suitable materials such as, for example, nylon or similar polymers having a stiffness that is sufficient to resist deformation by debris 14 from the window 12 while avoiding damage (i.e., scratching) to the window 12. It is to be appreciated that the bristle members 48 may be oriented in any number of configurations along the longitudinal axis L. For example, as illustrated in FIG. 4, the bristle members 48 may be arranged in a generally concentric pattern along the longitudinal axis L, and as illustrated in FIG. 5, the bristle members 48′ may be arranged in a generally helical pattern along the longitudinal axis L. Other examples are possible. With continued reference to FIGS. 4 and 5, in some of these examples, the elongated brush 46 is coupled with the motor 43 at one end thereof. However, in other examples and as illustrated in FIG. 6, the elongated brush 46 may be coupled with the motor 43 at a midpoint thereof. The elongated brush 46 may be removably coupled with the motor 43 to accommodate for the use of brushes having desired shapes, sizes, and/or other characteristics.

The controller 16 is in signal communication with the debris removal system 30. In some examples, the vehicle 10 may include at least one sensor, such as, for example, sensor 18 located near the window 12 at any desired location. In some examples, a first sensor 18 may be positioned at the lower portion 12a of the window 12, and a second sensor 18 may be positioned along a side edge 12c of the window 12. Any number of additional real and/or virtual sensors capable of sensing any number of characteristics of the debris removal system 30 and/or the vehicle 10 may be used and placed at desired locations of the vehicle 10. In some examples, the sensor 18 may be in the form of a position sensor. As a further example, any type of sensor capable of detecting a position of desired components of the debris removal system 30 (e.g., the wiper arm 34 and/or the elongated brush 46) may be used.

The controller 16 can be disposed in a number of positions with respect to the vehicle 10. As examples, the controller 16 can be disposed in an enclosure that is mounted in or near the cab and/or the engine bay of the vehicle 10. Other examples are possible. In some embodiments, the controller 16 can partially or fully control functions of the vehicle 10 via wired and/or wired signal communications as known and/or commonly used in the art.

More specifically, in some examples, the controller 16 may include software 16a adapted to control its operation, any number of hardware elements 16b (such as, for example, a non-transitory memory module and/or processors), any number of inputs and/or outputs 16c, and any number of connections 16d. The software 16a may be loaded directly onto a non-transitory memory module of the controller 16a in the form of a non-transitory computer readable medium or may alternatively be located remotely from the controller 16 and be in communication therewith via any number of controlling approaches. The software 16a includes logic, commands, and/or executable program instructions which may contain logic and/or commands for controlling specified operations of the vehicle 10. The software 16a may or may not include an operating system, an operating environment, an application environment, and/or a user interface.

The sensor or sensors 18 generate a signal which is transmitted to an input 16c of the controller 16. In the illustrated examples, the sensor/sensors 18 may be position sensors that generate signals based on a position of the wiper arm 34 and/or the elongated brush 46. The controller 16 can be set, configured, and/or programmed with logic, commands, and/or executable program instructions to send signals to control operation of the desired motor 33, 43 in the desired operational mode.

In operation, the debris removal system 30 may be engageable via a control interface 20 having any number of buttons 22. It is to be appreciated that in some examples, the buttons 22 may be in the form of any desired number of knobs, switches, and/or levers, and the like. Other examples are possible. The control interface 20 may be disposed on or near the vehicle operator's seating position. For example, the control interface 20 may be disposed on the vehicle dashboard, a steering column, or any other desired location generally accessible by the operator. In some examples, the button or buttons 22 may separately control actuation of the wiper assembly 32 and the rotatable brushing assembly 42. In such examples, the operator may engage a knob 22 corresponding to the desired assembly 32, 42, and the controller 16 may activate the motor 33 of the wiper assembly 32 and/or the motor 43 of the rotatable brushing assembly 42. It is to be appreciated that in these examples, the wiper assembly 32 may operate in a manner presently known (e.g., at variable speeds, intervals, and the like).

The rotatable brushing assembly 42 may be activated to spin the elongated brush 46 and sweep the elongated brush 46 along the wiping path A. Further, the motor 43 may be engaged to temporarily halt sweeping movement of the elongated brush 46 at a desired location along the wiping path A while still spinning, which may advantageously assist with removing or otherwise dislodging some forms of debris 14 from the window 12. In some examples, the buttons 22 may have different inputs and/or selections that cause the motor 43 to spin and/or sweep at varying speeds and/or directions. For example, the motor 43 may cause the elongated brush 46 to initially spin in a first direction at a first speed while traversing the wiping path A in an upward direction (at a desired sweeping speed), and subsequently may cause the elongated brush 46 to spin in a second, opposite direction at a desired rotational speed while traversing the wiping path A in a downward direction.

In some examples, the controller 16 may include logic to prevent the assemblies 32, 42, from inadvertently contacting each other in operation. More specifically, upon receiving an input from the knob(s) 22, the controller 16 may query the sensor or sensors 18 to determine relative positioning of the two assemblies 32, 42. If, for example, an operator engages the knob 22 corresponding to the rotatable brushing assembly 42, the software 16a may determine whether the wiper arm 34 is located in a position and/or moving in a direction that may result in unintended contact between the wiper arm 34 and the elongated brush 46.

In some arrangements, the controller 16 may include any number of interlocking features that cause the wiper arm 34 to “park” at a location in response to engagement of the rotatable brushing assembly 42. For example, in response to an operator pressing a desired knob 22, the controller 16 may engage the motor 33 of the wiper assembly 32 such that the wiper arm 34 moves along the wiping path A until the wiper arm 34 is adjacent to the side edge 12c of the window 12 (or, in some examples, until the wiper arm 34 is adjacent to the lower portion 12a of the window 12). The controller 16 may then disengage the motor 33, whereupon the wiper arm 34 may remain in a stationary, “upward” position that may accommodate travel of the elongated brush 46 along the wiping path A. Subsequently, the motor 16 may engage the motor 43 of the rotatable brushing assembly 42 to rotate and/or sweep the elongated brush 46 as desired. Upon disengaging the rotatable brushing assembly 42, the controller 16 may determine the position of the elongated brush 46 (e.g., that the elongated brush 46 is positioned at the lower portion 12a of the window 12) before engaging the motor 33 to move the wiper arm 34 to the lowered position. This delayed wiping operation of the wiper assembly 32 may allow the wiper blade 36 to successfully remove debris 14 dislodged or otherwise loosened by the elongated brush 46. Other examples of suitable approaches are possible.

While the above examples describe operation of a single one of the wiper assembly 32 or the rotatable brushing assembly 42, it is to be appreciated that in some examples, both the wiper assembly 32 and the brushing assembly 42 may be engaged simultaneously, whereupon both the wiper arm 34 and the elongated brush 46 may traverse the wiping path A in a singular sweeping motion. In yet other examples, the controller 16 may cause the wiping assembly 32 and the rotatable brushing assembly 42 to alternate traversing the wiping path A.

So arranged, the rotatable brushing assembly 42 may assist with removing, loosening, and/or dislodging debris 14 from the window 12, and the wiping assembly 32 may assist with further cleaning the window 12. In some examples, the wiping assembly 32 may be equipped with conventional fluid dispensing mechanisms to dispense a cleaning solution as desired. In some arrangements, the rotatable brushing assembly 42 may be equipped with its own fluid dispensing mechanism.

In some arrangements, the motor 43 may cause the elongated brush 46 to “pause” at a desired location along the wiping path A. More specifically, in some implementations, the sweeping operation of the motor 43 may be disengaged while the elongated brush 46 continues to spin about the longitudinal axis L. In these examples, the direction of rotation of the elongated brush 46 may be reversed, and the rotational speed may be increased or decreased as desired. Other examples are possible.

It is also to be appreciated that the debris removal system 30 may be provided in any number of alternative forms. For example, in some arrangements (not illustrated), the rotatable brushing assembly may be operably coupled with the wiper arm so that both the wiper blade and the elongated brush traverse the wiping path A at the same time.

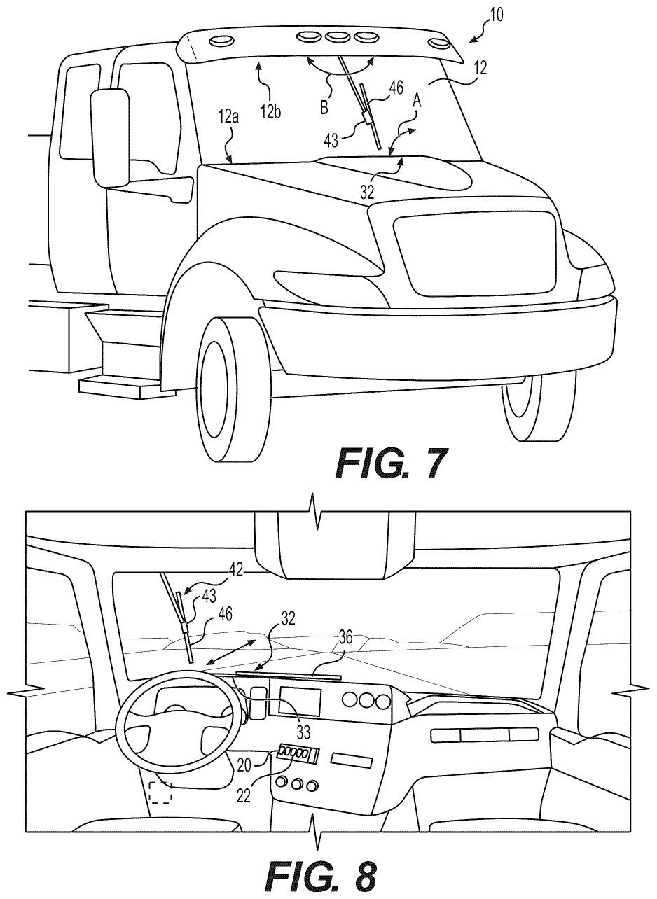

Further, in some examples and as illustrated in FIGS. 7 & 8, the rotatable brushing assembly 42 may be disposed at or near the upper portion 12b of the window (e.g., at or near a cowl portion of the window 12). In these examples, the wiper assembly 32 may be positioned at the lower portion 12a of the window or the upper portion 12b of the window 12. In these examples where the rotatable brushing assembly 42 is disposed at or near the cowl portion of the window 12, the elongated brush 46 may traverse or otherwise sweep along a different wiping path (generally denoted as “B” in FIGS. 7 & 8). Due to potential interference with the wiping path A, the controller may implement the previously-described “parking” feature and/or may alternate sweeping motions of the rotatable brushing assembly 42 and the wiper assembly 32. Other arrangements are possible.

So arranged, the systems described herein allow debris to be cleaned and removed from the windshield while the vehicle is still in motion (or, in some examples, stopped in traffic) as opposed to needing to exit the roadway to perform a thorough cleaning of the window. The systems described herein may use replaceable brushes and can accommodate brushes having varying stiffnesses, lengths, and/or other additional desired features. Further, the systems described herein may advantageously be used in other environments such as, for example, in agricultural vehicles, construction equipment, airport equipment, maritime vehicles, and any other system where an operator and/or an imaging system is intended to have a relatively unobstructed view of an external environment through a surface (e.g., a transparent or translucent window or screen) for safe operation.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Numerous alternative examples could be implemented, using either current technology or technology developed after the filing date of this patent, which would still fall within the scope of the claims. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting example the term is defined to be within 10%, in another example within 5%, in another example within 1% and in another example within 0.5%. The term “coupled” as used herein is defined as connected, although not necessarily directly and not necessarily mechanically. A device or structure that is “configured” in a certain way is configured in at least that way but may also be configured in ways that are not listed.

Further, unless expressly stated to the contrary, “or” refers to an inclusive or and not to an exclusive or. For example, “A, B or C” refers to any combination or subset of A, B, C such as (1) A alone, (2) B alone, (3) C alone, (4) A with B, (5) A with C, (6) B with C, and (7) A with B and with C. As used herein, the phrase “at least one of A and B” is intended to refer to any combination or subset of A and B such as (1) at least one A, (2) at least one B, and (3) at least one A and at least one B. Similarly, the phrase “at least one of A or B” is intended to refer to any combination or subset of A and B such as (1) at least one A, (2) at least one B, and (3) at least one A and at least one B.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter may lie in less than all features of a single disclosed example. Thus, the following claims are hereby incorporated into the Detailed Description, with each claim standing on its own as a separately claimed subject matter.

Finally, any references, including, but not limited to, publications, patent applications, and patents cited herein are hereby incorporated in their entirety by reference to the same extent as if each reference were individually and specifically indicated to be incorporated by reference and were set forth in its entirety herein.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality and improve the functioning of conventional computers.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

By way of example, and not limitation, the disclosure herein contemplates at least the following examples:
A. A debris removal system for a window of a vehicle, the debris removal system comprising: a wiper assembly including: 1) a wiper arm adapted to traverse a wiping path along the window, and 2) a wiper blade operably coupled with the wiper arm; and a rotatable brushing assembly including: 1) an elongated brush having a longitudinal axis, and 2) a motor operably coupled with a portion of the elongated brush, the motor adapted to rotate the elongated brush about the longitudinal axis; wherein at least a portion of the elongated brush is adapted to traverse the wiping path along the window.
B. The debris removal system of example A, wherein at least a portion of the rotatable brushing assembly is operably coupled with the wiper assembly.
C. The debris removal system of example B, wherein the elongated brush is operably coupled with the wiper arm.
D. The debris removal system of any one of examples A-C, further including a controller operably coupled with the wiper assembly and the rotatable brushing assembly to control operation thereof.
E. The debris removal system of example D, wherein the controller is adapted to move the wiper arm to a stationary position to accommodate travel of the elongated brush along the wiping path.
F. The debris removal system of example D or E, wherein the controller is adapted to pause the elongated brush at a desired location along the wiping path.
G. The debris removal system of any one of examples D-F, wherein the controller is adapted to cause the elongated brush to traverse the wiping path at a variable speed.
H. The debris removal system of example G, wherein the elongated brush is adapted to traverse the wiping path in a first direction at a first speed and traverse the wiping path in a second direction at a second speed.
I. The debris removal system of any one of examples D-H, wherein the controller is adapted to cause the elongated brush to selectively rotate in a first direction and a second direction.
J. The debris removal system of any one of examples A-I, wherein the rotatable brushing assembly is mounted at or near an upper portion of the window of the vehicle.
K. The debris removal system of example J, wherein the wiping path includes a wiper assembly path and a rotatable brushing assembly path, the wiper assembly path including a first arcuate pattern and the rotatable brushing assembly path including a second arcuate pattern, wherein the wiper assembly is adapted to traverse the wiper assembly path and the rotatable brushing assembly is adapted to traverse the rotatable brushing assembly path.
L. A method of removing debris from a vehicle, the method comprising: providing a wiper assembly including a wiper arm adapted to traverse a wiping path along a window of the vehicle, and a wiper blade operably coupled with the wiper arm; providing a rotatable brushing assembly including an elongated brush having a longitudinal axis, and a motor operably coupled with a portion of the elongated brush, the motor adapted to rotate the elongated brush about the longitudinal axis; and providing a controller communicatively coupled with the wiper assembly and the rotatable brushing assembly to control operation thereof, the controller adapted to cause at least a portion of the elongated brush to traverse the wiping path along the window.
M. The method of example L, wherein the controller is further adapted to cause the wiper assembly to move the wiper arm to a stationary position to accommodate travel of the elongated brush along the wiping path.
N. The method of example L or M, wherein the controller is further adapted to cause the elongated brush to pause at a desired location along the wiping path.
O. The method of any one of examples L-N, wherein the controller is further adapted to cause the elongated brush to traverse the wiping path at a variable speed.
P. The method of example O, wherein controller is adapted to cause the elongated brush to traverse the wiping path in a first direction at a first speed and traverse the wiping path in a second direction at a second speed.
Q. The method of any one of examples L-P, wherein the controller is further adapted to cause the elongated brush to selectively rotate in a first direction and a second direction.

What is claimed is:

1. A debris removal system for a window of a vehicle, the debris removal system comprising:
a wiper assembly including:
a wiper arm adapted to traverse a wiping path along the window, and
a wiper blade operably coupled with the wiper arm; and
a rotatable brushing assembly including:
an elongated brush having a longitudinal axis, and
a motor operably coupled with a portion of the elongated brush, the motor adapted to rotate the elongated brush about the longitudinal axis;
wherein at least a portion of the elongated brush is adapted to traverse the wiping path along the window.

2. The debris removal system of claim 1, wherein at least a portion of the rotatable brushing assembly is operably coupled with the wiper assembly.

3. The debris removal system of claim 2, wherein the elongated brush is operably coupled with the wiper arm.

4. The debris removal system of claim 1, further including a controller operably coupled with the wiper assembly and the rotatable brushing assembly to control operation thereof.

5. The debris removal system of claim 4, wherein the controller is adapted to move the wiper arm to a stationary position to accommodate travel of the elongated brush along the wiping path.

6. The debris removal system of claim 4, wherein the controller is adapted to pause the elongated brush at a desired location along the wiping path.

7. The debris removal system of claim 4, wherein the controller is adapted to cause the elongated brush to traverse the wiping path at a variable speed.

8. The debris removal system of claim 7, wherein the elongated brush is adapted to traverse the wiping path in a first direction at a first speed and traverse the wiping path in a second direction at a second speed.

9. The debris removal system of claim 4, wherein the controller is adapted to cause the elongated brush to selectively rotate in a first direction and a second direction.

10. The debris removal system of claim 1, wherein the rotatable brushing assembly is mounted at or near an upper portion of the window of the vehicle.

11. The debris removal system of claim 10, wherein the wiping path includes a wiper assembly path and a rotatable brushing assembly path, the wiper assembly path including a first arcuate pattern and the rotatable brushing assembly path including a second arcuate pattern, wherein the wiper assembly is adapted to traverse the wiper assembly path and the rotatable brushing assembly is adapted to traverse the rotatable brushing assembly path.

12. A method of removing debris from a vehicle, the method comprising:
providing a wiper assembly including a wiper arm adapted to traverse a wiping path along a window of the vehicle, and a wiper blade operably coupled with the wiper arm;
providing a rotatable brushing assembly including an elongated brush having a longitudinal axis, and a motor operably coupled with a portion of the elongated brush, the motor adapted to rotate the elongated brush about the longitudinal axis; and
providing a controller communicatively coupled with the wiper assembly and the rotatable brushing assembly to control operation thereof, the controller adapted to cause at least a portion of the elongated brush to traverse the wiping path along the window.

13. The method of claim 12, wherein the controller is further adapted to cause the wiper assembly to move the wiper arm to a stationary position to accommodate travel of the elongated brush along the wiping path.

14. The method of claim 12, wherein the controller is further adapted to cause the elongated brush to pause at a desired location along the wiping path.

15. The method of claim 12, wherein the controller is further adapted to cause the elongated brush to traverse the wiping path at a variable speed.

16. The method of claim 15, wherein controller is adapted to cause the elongated brush to traverse the wiping path in a first direction at a first speed and traverse the wiping path in a second direction at a second speed.

17. The method of claim 12, wherein the controller is further adapted to cause the elongated brush to selectively rotate in a first direction and a second direction.
